(19) United States
(12) Patent Application Publication
(10) Pub. No.: US 2008/0113327 A1
(43) Pub. Date: May 15, 2008

(54) INTERACTIVE SYSTEM FOR TEACHING AND LEARNING ALGORITHMS THROUGH DISCOVERY

(75) Inventor: Jean-Marie H. Larcheveque, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/558,565

(22) Filed: Nov. 10, 2006

(51) Int. Cl. G09B 3/00

(52) U.S. Cl. 434/350

(57) ABSTRACT

The claimed subject matter pertains to systems and methods that facilitate learning of algorithms through incremental discovery in an interactive environment. An algorithm can be decomposed into its base parts and a representation of the algorithm and its parts can be presented to the user in the form of puzzles and/or quizzes. The user can learn the algorithm by solving a sequence of puzzles and/or quizzes that lead the user to reinvent the logical and strategic thinking associated with the algorithm.

### BACKGROUND

Algorithms are useful tools for problem solving; and understanding how algorithms work, and how to design them facilitates many problem-solving professions, especially computer science. For example, in writing programming code to implement a desired solution to a problem that can be resolved via an algorithm, the programmer should first understand how to design the algorithm that will solve the problem before he can write code implementing it.

There have been attempts at teaching students algorithms in various ways, such as for example by animating execution of an algorithm. However, when a student is trying to learn an algorithm by observing an animation of execution thereof, the student does not have the benefit of being integrally involved in seeing how the algorithm is constructed. While animating execution of an algorithm may possibly be entertaining, if done well, it does not permit a person to be interactively involved in learning how constituent parts of the algorithm fit and work together.

### SUMMARY

The following presents a simplified summary in order to provide a basic understanding of some aspects of the claimed subject matter. This summary is not an extensive overview of the claimed subject matter and is not intended to identify key/critical elements or to delineate the scope of such subject matter. Its sole purpose is to present some concepts in a simplified form as a prelude to the more detailed description that is presented later.

An interactive teaching/learning system and methodologies that can assist a user in learning algorithms by discovery of logic of the algorithms are presented. Such system and methods can increase a user's involvement in learning base elements that make up an algorithm, increase critical thinking with regard to learning algorithms as well as design and construction of algorithms, and enhance problem-solving skills, all of which can help the user with future problem-solving tasks.

The claimed subject matter disclosed and claimed herein, in one aspect thereof, comprises a system of learning algorithms by incremental algorithm discovery. More specifically, described herein are systems and methods that can be employed to decompose an algorithm into puzzles and/or quizzes, so that a user can discover logic of the algorithm through interactive manipulation of graphic objects using a puzzle-solving approach. Such systems and methods can be employed in a classroom context or a self-study context, for example. According to an aspect of the claimed subject matter, a sequence of puzzles and/or quizzes that are representative of an algorithm can be presented for solving by a user. For example, a puzzle can be presented in a puzzle display for the user to solve—the puzzle can be a representation of one of a plurality of base parts that together make up an algorithm. The puzzle can include graphical objects (e.g., puzzle objects) that the user can manipulate using controls (e.g., a mouse, a keyboard) in order to solve the puzzle, although the claimed subject matter is not so limited.

Once the user has solved the puzzle, the user can be presented with a quiz, which can be a set of questions that call for multiple-choice or text responses, for example. For instance, the quiz can be used as an explanatory transition between puzzles in order to facilitate discovery of concepts necessary to solve subsequent puzzles and/or invite analysis of the solution found to the puzzle, among other uses. The user can then continue to proceed through the sequence of puzzles and quizzes until the entire algorithm is learned. The user's progress is continuously monitored as the user works through the puzzles and quizzes, and feedback information associated with the user's actions with regard to the puzzles and quizzes can be generated and provided to the user to assist the user in learning algorithms.

In accordance with another aspect of the claimed subject matter, a smart object can be created and employed to reuse the solution of a puzzle(s) and/or quiz(zes). An exemplary use of smart objects is to facilitate discovery of a recursive algorithm through induction. In this approach, the handling of a base case is solved as a preliminary puzzle, after which a puzzle can teach the induction step by providing a smart object whose behavior encapsulates the base case just discovered. For example, once a puzzle has been solved, a smart object can be created that encapsulates the behavior of the algorithm, or part thereof, that has been or can be discovered by means of the puzzle. A user can then use the smart object in future puzzles, when such future puzzles can be solved, at least in part, by using the solution provided by the smart object.

According to yet another aspect of the claimed subject matter, artificial intelligence techniques can be employed to, for example, facilitate tailoring feedback information given to a user regarding a puzzle or quiz based in part on historical and/or current actions of the user. In this manner, the user's learning experience can be enhanced, and the learning process can be more efficient.

To the accomplishment of the foregoing and related ends, certain illustrative aspects are described herein in connection with the following description and the annexed drawings. These aspects are indicative of various ways in which the claimed subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a system that facilitates learning of an algorithm in accordance with an aspect of the present invention.

FIG. 2 illustrates a block diagram of a system that facilitates learning of algorithms in accordance with an aspect of the present invention.

FIG. 3 illustrates a block diagram of a system that facilitates learning of algorithms in accordance with an aspect of the present invention.

FIG. 4 illustrates a block diagram of a system that facilitates the creation of a puzzle(s) representative of an algorithm in accordance with an aspect of the present invention.

FIG. 5 is a representative flow diagram illustrating a method of facilitating learning an algorithm in accordance with an aspect of the present invention.

FIG. 6 is a representative flow diagram illustrating a methodology for creating a smart object in accordance with an aspect of the present invention.

FIG. 7 is a representative flow diagram illustrating a method for facilitating coding associated with a puzzle in accordance with an aspect of the present invention.

FIG. 8 is a representative flow diagram illustrating a methodology of animating a puzzle in accordance with an aspect of the present invention.

FIG. 9 is an illustration of an example of a puzzle that can be used in accordance with an aspect of the present invention.

FIG. 10 is an illustration of an example of grouping puzzle objects based on a solution to a puzzle in accordance with an aspect of the present invention.

FIG. 11 is an illustration of another example of grouping puzzle objects based on a solution to a puzzle in accordance with an aspect of the present invention.

FIG. 12 is an illustration of an example of utilizing a grouped object to solve another puzzle in accordance with an aspect of the present invention.

FIG. 13 is an illustration of an example of a puzzle representative of a sorting algorithm that can be used in accordance with an aspect of the present invention.

FIG. 14 is an illustration of another example of a puzzle representative of a sorting algorithm that can be used in accordance with an aspect of the claimed subject matter

FIG. 15 is a schematic block diagram illustrating a suitable operating environment.

FIG. 16 is a schematic block diagram of a sample-computing environment.

### DETAILED DESCRIPTION

The various aspects of the claimed subject matter are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over the other aspects or designs.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but is not limited to magnetic storage devices (e.g., hard disk, floppy disk, magnetic strips . . . ), optical disks (e.g., compact disk (CD), digital versatile disk (DVD . . . )), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

The claimed subject matter generally relates to an interactive teaching/learning system and methodologies that can assist a user in learning algorithms by discovery of logic of the algorithms. Learning an algorithm is facilitated by having the user (e.g., student) be integrally involved in discovery of the algorithm. The foregoing can be accomplished by representing the algorithm in the form of a puzzle(s), as well as a quiz(zes), to be solved by the user. Other exercises can be utilized to assist the user in learning the algorithm as well. The user can manipulate a puzzle object(s) to solve the puzzle, where the action taken in solving the puzzle can correspond to the behavior or function of the algorithm. A quiz(zes) or other exercise can further facilitate algorithm learning by reinforcing what was learned when solving the puzzle, among other features.

Learning an algorithm through such interactive discovery can increase a user's involvement in learning the algorithm, increase the user's critical thinking, and enhance the user's problem-solving skills, all of which can help the user with future problem-solving tasks.

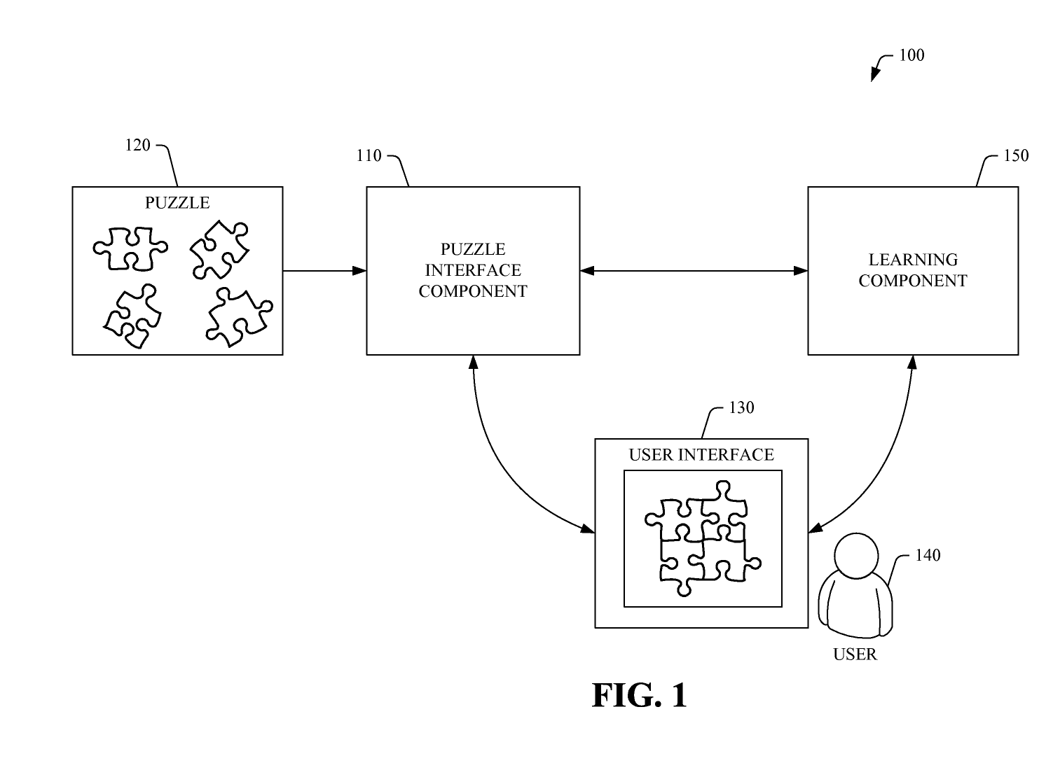

Turning now to FIG. 1, an illustration of a system 100 that facilitates learning of an algorithm is depicted. In an aspect of the claimed subject matter, a puzzle interface component 110 can facilitate the retrieval of one or more puzzles 120 that can be representative of an algorithm deconstructed into one or more base parts, where each base part can be represented as a puzzle. A base part of an algorithm can include any portion of the algorithm capable of being represented by a puzzle, including one or more components, one or more functions, one or more procedures, or one or more steps, of the algorithm, for example. For example, a puzzle 120 can be such that it models a corresponding base part of the algorithm, and the action taken in solving the puzzle correlates to the function of the base part of the algorithm. The puzzle interface component 110 can be associated with a user interface 130 that can facilitate presentation of the puzzle to a user 140 for the user to solve. The puzzle can be comprised of graphical objects (e.g. puzzle objects) that the user 140 can manipulate in order to solve the puzzle 120, for example. The puzzle interface component 110 also can be associated with a learning component 150 that can monitor the status of the puzzle 120, among other features.

The learning component 150 can be associated with the user interface 130 and can facilitate monitoring the user's progress in solving a puzzle 120 and providing feedback information to the user 140 associated with the puzzle 120 and the user's action with regard to the puzzle, as the user 140 attempts to solve the puzzle 120. The learning component 150 can receive information associated with the puzzle 120 from the puzzle interface component 110 and the user interface 130 and can monitor the user's progress in solving the puzzle 120. The learning component 150 can analyze the progress information and generate feedback information associated with the user's action with regard to the puzzle 120. The learning component 150 can provide the feedback information to the user 140. For example, if the user 140 makes an illegal move, the learning component 150 can monitor the move, generate feedback information regarding the illegal move by the user 140, and then send feedback information to the user 140 via the user interface 130 to give the user 140 notice that an illegal move was made. The learning component 150 can also send notice of the illegal move to the puzzle interface component 110, which can then return the puzzle 120 back to its state prior to the illegal move, for example. As another example, the learning component 150 can generate and provide feedback information to the user 140 in the form of comments or hints associated with the puzzle 120, although the claimed subject matter is not so limited. The feedback information can be in any form or manner that can convey information to the user 140, including but not limited to, visual information (e.g., graphical object), audible information (e.g., bell, buzzer), and/or textual information.

Once the user has solved the puzzle 120, the learning component 150 can generate and present a quiz associated with the puzzle 120 to the user 140 for the user 140 to complete. The quiz can be structured in various forms, including a multiple-choice quiz or textual-answer quiz, for example. The quiz can be in the form of an explanatory quiz that can assist the user 140 in transitioning between puzzles 120 in a sequence of puzzles associated with an algorithm. The quiz can reinforce what has just been learned by solving the puzzle 120. Further, the quiz can assist the user 140 by defining a smart object, to help the user 140 discover concepts necessary to solve subsequent puzzles 120, or to invite analysis of a solution for the puzzle 120 just solved, for example.

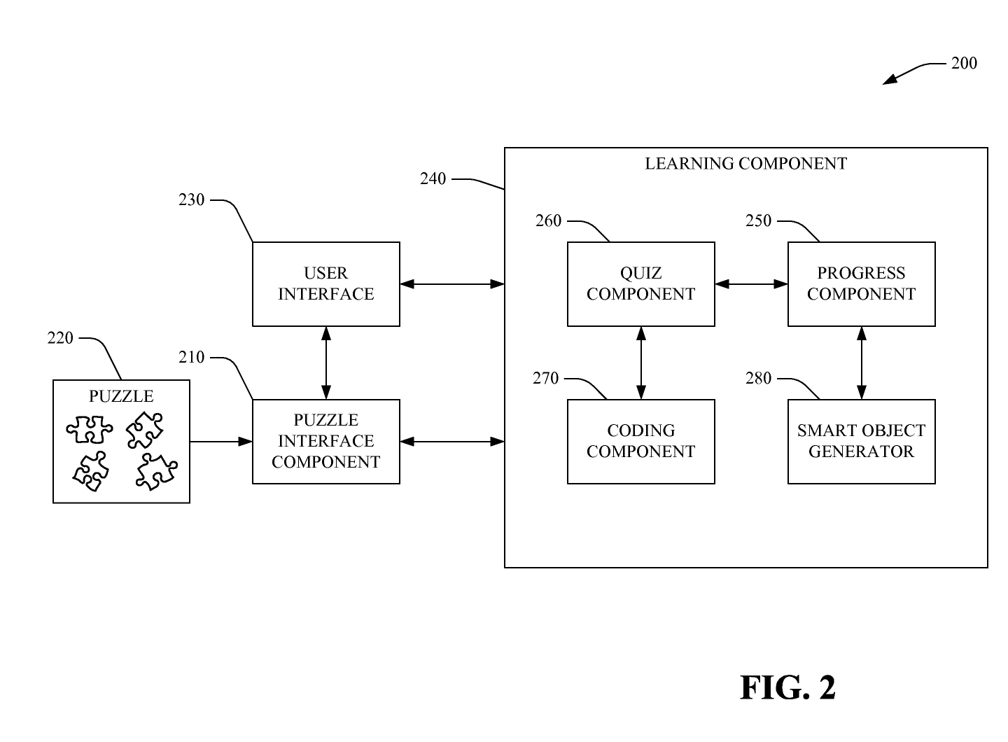

FIG. 2 illustrates a system 200 that facilitates learning of algorithms in accordance with an aspect of the claimed subject matter. System 200 includes a puzzle interface component 210 that can retrieve one or more puzzles 220 that can be representative of and correspond to base parts of a decomposed algorithm. The puzzle interface component 210 can be associated with a user interface 230 that can facilitate presenting the puzzle 220 to the user for the user to solve, so that as the user solves the puzzle, the user learns the underlying algorithm, or base part thereof. The puzzle 220 can comprise graphical objects (e.g., puzzle objects) that can be manipulated by the user utilizing controls (e.g., a mouse, a keyboard) in the user interface 230.

System 200 also includes a learning component 240 that facilitates the learning of algorithms by the user. The learning component 240 can be associated with the puzzle interface component 210 and the user interface 230, and can facilitate receiving information from the puzzle interface component 210 and the user interface 230 with regard to the status of the puzzle 220 and the user's action and progress in solving the puzzle 220. The learning component 240 can include a progress component 250 that can monitor and receive information associated with the puzzle 220 and the user, including monitoring the user's action and progress in solving the puzzle 220. The progress component 250 can then analyze the received information and generate appropriate feedback information based in part on the puzzle 220 and the user's action in solving the puzzle 220 and provide it to the user via the user interface 230. For example, the feedback information can include progress information regarding the user, performance information regarding the user, and recommendation information regarding action that can be taken by the user, associated with the user's actions with regard to the puzzle, in addition to other types of feedback information that can be provided to the user. The feedback information can be utilized to assist the user in solving the puzzle.

As another example, if the user makes an illegal move, the learning component 240 can monitor the move, generate feedback information regarding the illegal move by the user, and then send feedback information to the user via the user interface 230 to give the user notice that an illegal move was made. The learning component 240 can also send notice of the illegal move to the puzzle interface component 210, which can then return the puzzle 220 back to its state prior to the illegal move, for example. In addition, the learning component 240 can generate and provide feedback information to the user in the form of comments or hints associated with the puzzle 220, although the claimed subject matter is not so limited. The feedback information can be in any form or manner that can convey information to the user, including but not limited to, visual information (e.g., graphical object), audible information (e.g., bell, buzzer), and/or textual information.

The learning component 240 can further include a quiz component 260 that can facilitate presenting one or more quizzes to the user associated with the puzzle 220 and the algorithm, or part thereof, represented by the puzzle 220. A quiz can be structured in various forms, including a quiz that calls for multiple-choice responses or textual responses, for example. The quiz can be in the form of an explanatory quiz that can assist the user in transitioning between puzzles 220 in a sequence of puzzles associated with an algorithm. Further, the quiz can assist the user by defining a smart object, to help the user discover concepts necessary to solve subsequent puzzles, or to invite analysis of a solution for the puzzle 220 just solved, for example.

The quiz component 260 can be associated with the progress component 250, such that the progress component 250 can monitor and receive information associated with the user's responses to quiz questions via the user interface 230. The progress component 250 can then analyze the received information and generate appropriate feedback information based in part on the quiz and the user's action in solving the quiz and provide the feedback information to the user via the user interface 230. For example, the feedback information can include progress information regarding the user, performance information regarding the user, and recommendation information regarding action that can be taken by the user, associated with the user's actions with regard to the quiz, in addition to other types of feedback information that can be provided to the user. The feedback information can be utilized to assist the user in solving the quiz.

The quiz component 260 can also be associated with a coding component 270, which can be included in the learning component 240, to facilitate the presentation of a coding quiz to the user, among other features. As part of a coding quiz, the coding component 270 can facilitate the presentation of a code editor display in the user interface 230, and the user can drag puzzle object(s) (or the entire puzzle 220) into the code editor display in the user interface 230. In one embodiment, the code editor display can be part of an Integrated Development Environment, such as Visual Studio, for example. Upon dragging puzzle object(s) into the code editor display, the coding component 270 can automatically convert the puzzle object(s) into one or more empty functions and headers associated with the puzzle object(s) and its associated algorithm, or corresponding base part thereof, so that the user can translate the actions related to solving the puzzle into executable code that upon execution thereof will model the actions related to manipulating the puzzle object(s) and solving the puzzle 220. In one embodiment, the puzzle interface component 210 can be synchronized with the code editor display, so that taking an action with regard to a puzzle object in the puzzle interface component 210 can insert, in the code editor display, a comment corresponding to and describing the action taken regarding the puzzle object. The user can use such comments to assist the user in solving the coding quiz thereby allowing the user to naturally transition from interactive discovery to coding.

System 200 can also include a smart object generator 280 that can facilitate the reuse of solutions to puzzles or quizzes in future puzzles or quizzes. After the user solves the puzzle 220 and a quiz, associated with a puzzle 220, that leads to discovery of the behavior associated with a smart object, the smart object generator 280 can generate a smart object that can encapsulate the behavior of an associated algorithm, or base part thereof The smart object can be a graphical object that can be available to and utilized by the user in the user interface 230. Thus, the smart object can be manipulated like a puzzle object. The smart object can also be utilized in a quiz. For example, in a coding quiz, the smart object can be dragged into the code editor display, where it can be automatically converted into a corresponding function and header, so that the user can insert code to translate the smart object into code. Once generated, a smart object can be utilized in a future puzzle and/or quiz when the solution, or a partial solution, to the future puzzle and/or quiz can be realized using the smart object.

One use of smart objects is to facilitate discovery of a recursive algorithm through induction. For example, a base case of an algorithm can be solved by solving a preliminary puzzle representative of the base case. Once the preliminary puzzle is solved, a subsequent puzzle can teach the induction step by providing a smart object, whose behavior encapsulates the base case just discovered, for use in solving the subsequent puzzle.

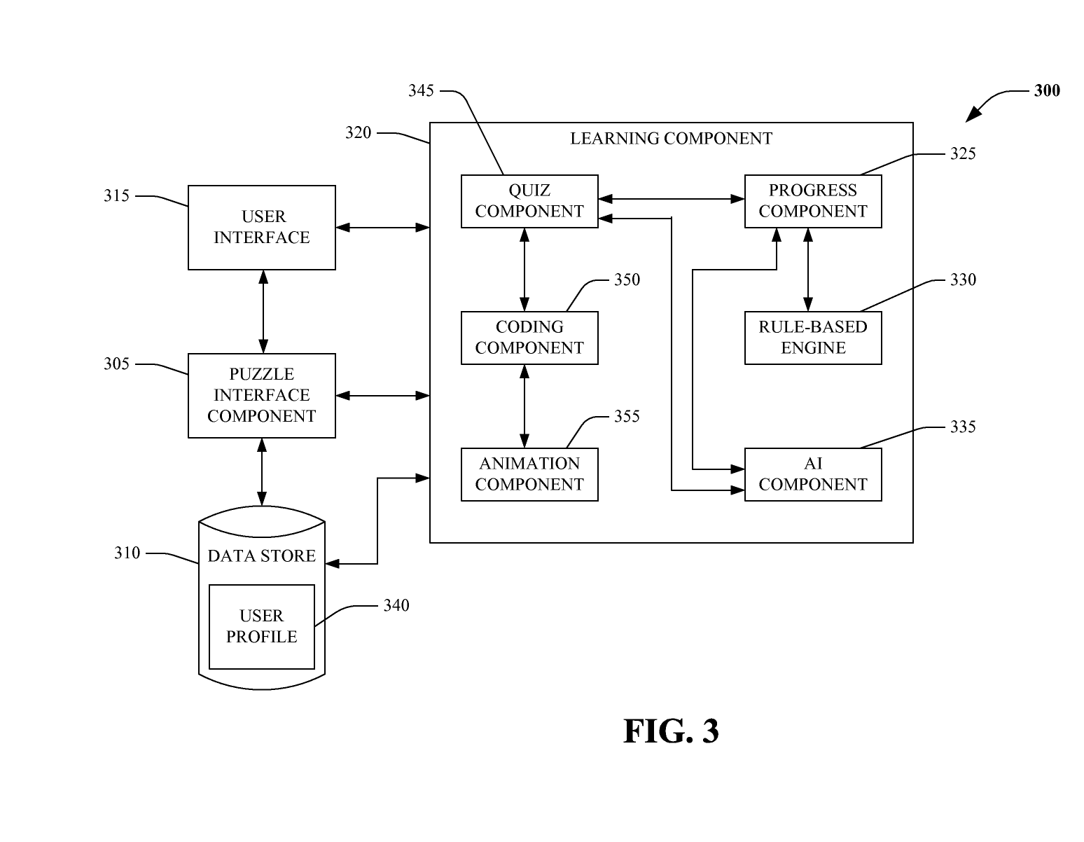

FIG. 3 illustrates a system 300 that facilitates learning of algorithms in accordance with an aspect of the claimed subject matter. System 300 can include a puzzle interface component 305 that can retrieve one or more puzzles that are representative of an algorithm, or a base part thereof, where the algorithm has been decomposed into base parts, and can present the one or more puzzles to a user. In one embodiment of the claimed subject matter, the one or more puzzles can be stored in and retrieved by the puzzle interface component 305 from a data store 310 associated therewith. The data store 310 can be any data storage device, such as a hard drive, random access memory, read only memory, removable media, CD-ROMS, and the like. Further, the data store 310 can be accessed via a network connection (e.g., an online data store accessible through a website). The puzzle interface component 305 can be associated with a user interface 315 that can facilitate presenting a puzzle to a user in a puzzle display in the user interface 315. The puzzle can be comprised of one or more graphical objects (e.g., puzzle objects) representative of an algorithm, or a base part thereof. The user can attempt to solve the puzzle by manipulating and/or moving the puzzle objects using various controls (e.g., a mouse, a keyboard) available in the user interface 315.

The system 300 further includes a learning component 320, associated with the puzzle interface component 305 and the user interface 315, that can facilitate learning of algorithms, in part, by providing, to the user, feedback information associated with the puzzle and the actions of the user in attempting to solve the puzzle. The learning component 320 can monitor and receive information regarding action taken in the user interface 315 and the puzzle interface component 305. The learning component 320 can include a progress component 325 that can monitor and receive information associated with the user's progress in solving the puzzle as well as other action of the user in the user interface 315, although the invention is not so limited. In one aspect of the claimed subject matter, the progress component 325 can be associated with a rule-based engine 330, which can be included in the learning component 320, and can analyze received information associated with the action of the user in solving the puzzle and compare such action to a predetermined set of rules associated with the puzzle that can be provided by the rule-based engine 330. The progress component 325 can generate feedback information constructed based in part on the analysis by the rule-based engine 330, and then provide the feedback information to the user. For example, if the user makes an illegal move with regard to moving a puzzle object, that is, a move that violates the rules of the puzzle, the progress component 325 can monitor and receive the information regarding the move, and transmit that information to the rule-based engine 330. The rule-based engine 330 can analyze the move, compare the move to a predefined rule set, and determine whether a rule has been violated; if so, the rule-based engine can send information regarding the rule violation to the progress component 325, which can then generate feedback information regarding the illegal move and send notice to the user via the user interface 315 that the move was illegal. The notice can be in the form of a textual message, a graphical symbol, and/or audible signal associated with the illegal move, for example. The progress component 325 can also notify the puzzle interface component 305 of the illegal move, and the puzzle interface component 305 can return the puzzle to its state prior to the illegal move. The feedback information can comprise any type of information associated with the user's actions with regard to the puzzle, including progress information regarding the user, performance information regarding the user, and recommendation information regarding action that can be taken by the user, in addition to other types of feedback information that can be provided to the user. For example, the progress component 325 can generate feedback information in the form of comments, including hints to solving the puzzle, to the user.

In one embodiment of the claimed subject matter, the progress component 325 can be associated with an artificial intelligence (AI) component 335. The feedback information provided by the progress component 325 can be based in part on determination and/or inferences made by the AI component 335. The AI component 335 can examine the entirety or a subset of the data stored by the data store 310 and can provide for reasoning about or infer states of the system, environment, and/or user from a set of observations as captured via events and/or data. Data or a subset of the data associated with a user can be stored in a user profile 340 which can be stored in the data store 310, although the claimed subject matter is not so limited, as the user profile 340 can be stored in any storage device that can be accessed by the AI component 325. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines) can be employed in connection with performing automatic and/or inferred action in connection with the claimed subject matter.

The AI component 335 can make an inference regarding what feedback information, or what subset of feedback information, to present to the progress component 325, and thereby to the user via the user interface 315. The feedback information can be based in part on current or past actions associated with the user. For example, the AI component 335 can make an inference as to whether a user needs assistance in solving a puzzle and can further infer what type of assistance the user may need based on current and prior events associated with the user and/or other users. As another example, the user interface 315 can include sensors, such as audio and visual sensors, that can observe a user's presence and/or activity with regard to a task (e.g., puzzle, quiz, coding . . . ) and the user interface 315. Information received from these sensors can be analyzed and an inference can be rendered based on such information. For instance, while solving a puzzle in the user interface 315, a user may move the mouse over a puzzle object, click on it to drag it, and then begin dragging the puzzle object; but then pause for a significant period of time. Based on current and/or past events, the AI component 335 can make an inference regarding whether the user needs assistance with that task, or can make some other inference related to an action to be taken.

In an aspect of the claimed subject matter, once the user has successfully solved the puzzle, a quiz component 345, which can be included in the learning component 320, can facilitate presenting one or more quizzes to the user in the user interface 315. A quiz can be in various forms, such as a multiple-choice quiz or a quiz that calls for textual responses, for example. In one aspect of the claimed subject matter, the quiz can be an explanatory quiz that can be given to accomplish various objectives, such as to define a smart object, to help the user discover concepts necessary to solve subsequent puzzles, and/or to invite analysis of the puzzle solution just found. The quiz component 345 can be associated with the progress component 325, and the progress component 325 can monitor and receive information associated with the user's actions with regard to the quiz. The progress component 325 can generate feedback information associated with the quiz and the user's action, and provide the feedback information to the user. The feedback information can comprise any type of information associated with the user's actions with regard to the quiz, including progress information regarding the user, performance information regarding the user, and recommendation information regarding action that can be taken by the user, in addition to other types of feedback information that can be provided to the user. For example, the progress component 325 can inform the user that a quiz question was answered incorrectly, or provide the user with a message that gives the user a hint regarding correctly solving the quiz.

In another aspect of the claimed subject matter, the learning component 320 can include a coding component 350 that is associated with the quiz component 345, so that the coding component 350 can be utilized during a quiz. For example, one type of quiz where the coding component 350 can be utilized is a coding quiz. The coding component 350 can facilitate providing a code editor display in the user interface 315 to facilitate displaying comments and/or code associated with a particular puzzle or quiz. A puzzle object(s) can be dragged (e.g., by clicking on it and moving it using a mouse) into the code editor display in the user interface 315 where a function(s) and header(s) associated with the puzzle object(s) (and the algorithm element(s) represented by the puzzle object(s)) can be automatically generated and displayed in the code editor display. In one embodiment, upon dragging a puzzle object(s) into the code editor display, the coding component 350 can automatically generate comments describing the function and/or exemplary code language (e.g., C#) executable to perform the function associated with the puzzle and the underlying algorithm, or base part thereof, represented by the puzzle. The comments and/or code can be displayed in the code editor display in the user interface 315. For example, where a puzzle object relates to an array, dragging the puzzle object into the code editor display can automatically translate the puzzle object into an empty function with a header showing the associated array being passed as a parameter. In another embodiment, the puzzle display and code editor display can be synchronized such that when the puzzle object is dragged from the puzzle display into the code editor display, a comment that describes a function associated with the puzzle object can be automatically generated and displayed in the code editor display.

The learning component 320 can further include an animation component 355 that is associated with the coding component 350 and can facilitate reinforcing the algorithm, or base part thereof, just discovered by the user. In one embodiment, the user can insert code associated with a puzzle, or part thereof, in the code editor display in the user interface 315. In another embodiment, exemplary code (e.g., C#) associated with a puzzle, or part thereof, can be automatically generated by the coding component 350 and displayed in the code editor display in the user interface 315. When the code is in the code editor display, the animation component 355 can be employed to execute the code and animate the execution of the puzzle in the puzzle display in the user interface component 315, thereby executing the underlying algorithm, so that the user can visually observe the puzzle objects being animated to solve the puzzle. Such animation can reinforce what has just been learned by the user. Further, in cases where the user has inserted the code into the code editor display, for example, such animation can assist the user in determining whether the puzzle has been solved in the most efficient way possible.

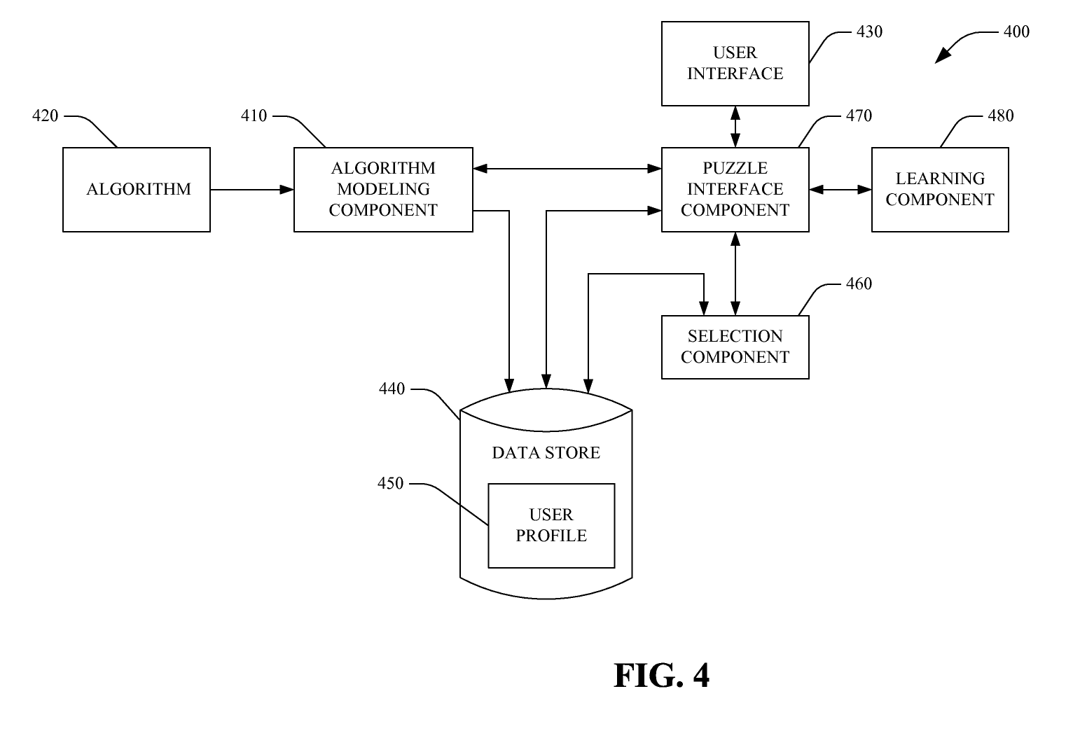

Referring to FIG. 4, in accordance with yet another aspect of the claimed subject matter, a system 400 that facilitates the creation of a puzzle(s) representative of an algorithm is illustrated. System 400 can include an algorithm modeling component 410 that can receive an algorithm 420 and deconstruct the algorithm 420 into its base parts. A base part of an algorithm 420 can be any portion of the algorithm 420 capable of being represented by a puzzle, or a part thereof, including one or more components, one or more functions, one or more procedures, or one or more steps, of the algorithm 420, for example. The algorithm modeling component 410 can be associated with a user interface 430 that can facilitate the generation of puzzles representative of and corresponding to an algorithm 420, or base parts thereof, and quizzes and/or other exercises associated with the algorithm 420. The algorithm modeling component 410 can also be associated with a data store 440 that can store the base parts of the algorithm 420. The data store 440 can be any data storage device, such as a hard drive, random access memory, read only memory, removable media, CD-ROMS, and the like. Further, the data store 440 can be accessed via a network connection (e.g., an online data store accessible through a website). The data store 440 can include a user profile 450 for storing algorithms 420, and puzzles, quizzes, and/or other exercises associated with respective algorithms 420, associated with a user.

The system 400 can further include a problem selection component 460 that can be associated with the data store 440 and can select a puzzle, quiz, and/or other exercise to be retrieved from the data store 440 for presentation to a user. In one aspect of the claimed subject matter, the problem selection component 460 can automatically select a puzzle, quiz, or exercise to be presented. In another aspect, the problem selection component 460 can allow the user to select a puzzle, quiz, or exercise. The problem selection component 460 can further be associated with a puzzle interface component 470 that can facilitate retrieval of the selected puzzle, quiz, and/or other exercise from the data store 440 associated with the puzzle interface component 470. The puzzle interface component 470 can further be associated with a learning component 480 that can facilitate monitoring the user's progress in solving a puzzle and providing feedback information to the user associated with the puzzle and the user's action with regard to the puzzle, as the user attempts to solve the puzzle.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

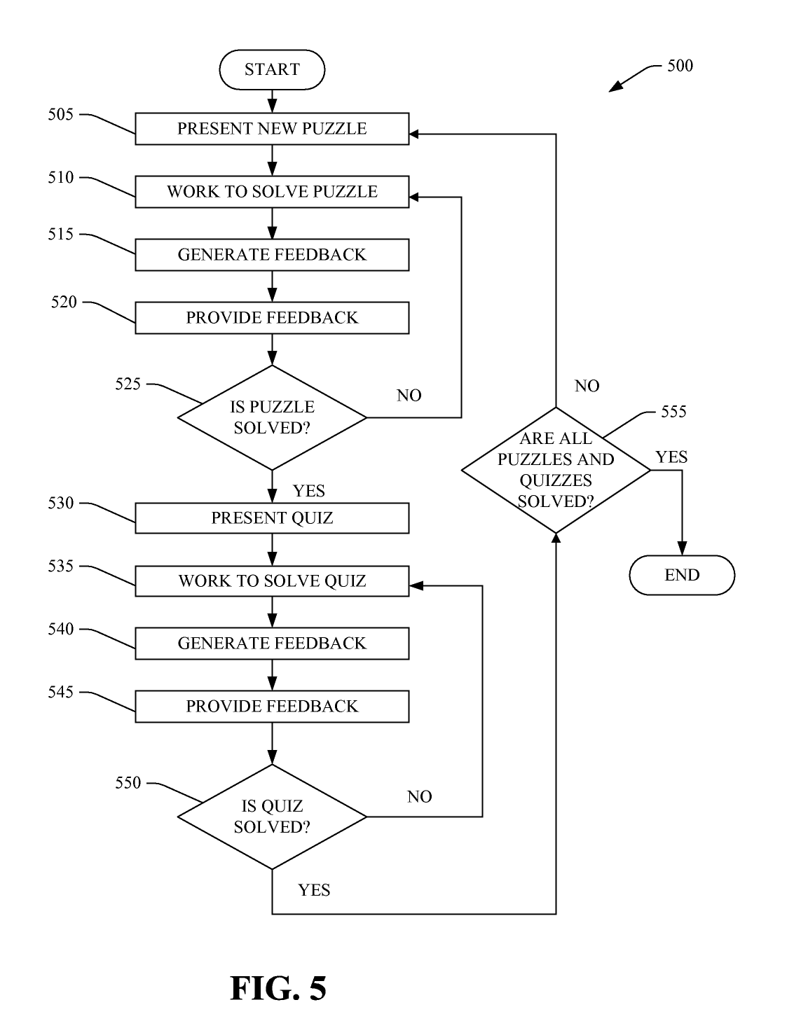

In view of the exemplary systems described supra, methodologies that may be implemented in accordance with the disclosed subject matter will be better appreciated with reference to the flow charts of FIGS. 5-8. While for purposes of simplicity of explanation, the methodologies are shown and described as a series of acts, it is to be understood and appreciated that the claimed subject matter is not limited by the order of the acts, as some acts may occur in different orders and/or concurrently with other acts from what is depicted and described herein. Moreover, not all illustrated acts may be required to implement the methodologies described hereinafter.

Turning now to FIG. 5, a method of facilitating learning an algorithm is depicted in accordance with an aspect of the claimed subject matter. At 505, a puzzle corresponding to and representative of an algorithm, or a base part thereof, is presented for a user to solve. At 510, work is performed to solve the puzzle. At 515, feedback information regarding the user's action with regard to the puzzle can be generated. At 520, feedback information regarding the user's action with regard to solving the puzzle, or attempts to solve the puzzle, can be sent to the user. The feedback information can comprise any type of information connected with the user's actions with regard to the puzzle, including progress information regarding the user, performance information regarding the user, and recommendation information regarding action that can be taken by the user, or subsets thereof, in addition to other types of feedback information that can be provided to the user. For example, the user can be presented with feedback information in the form of a textual message, a graphical object, and/or an audible tone, informing the user that he has made an illegal move. In such a case, the puzzle can be returned to its state prior to the illegal move and the user can proceed from that point to continue solving the puzzle. At 525, a determination can be made as to whether the puzzle has been solved or otherwise completed. If the puzzle is not yet solved or otherwise completed, there is a return back to 510 to continue to solve the puzzle. If the puzzle has been solved or otherwise completed, the process can continue to 530 where the user can be presented a quiz, for example an explanatory quiz, associated with the puzzle and underlying algorithm, for the user to solve. At 535, the user works to solve the quiz, which can be in the form of questions calling for multiple-choice or textual responses, for example. At 540, feedback information regarding the user's action with regard to solving or completing the quiz can be generated. At 545, feedback information regarding solving, or attempting to solve, the quiz can be sent to the user. The feedback information can comprise any type of information associated with the user's actions with regard to the quiz, including progress information regarding the user, performance information regarding the user, and recommendation information regarding action that can be taken by the user, or subsets thereof, in addition to other types of feedback information that can be provided to the user. At 550, a determination can be made as to whether the quiz has been solved or otherwise completed. If the quiz has not yet been solved or otherwise completed, there is a return back to 535 to continue solving the quiz. If the quiz has been solved or otherwise completed, the process can continue to 555, where a determination is made as to whether all puzzles and quizzes associated with the algorithm have been solved or otherwise completed. If all of the puzzles and quizzes have not yet been solved, there is a return back to 505, where a new puzzle can be presented, and the process can continue. If all puzzles and quizzes have been solved or otherwise completed, the process ends.

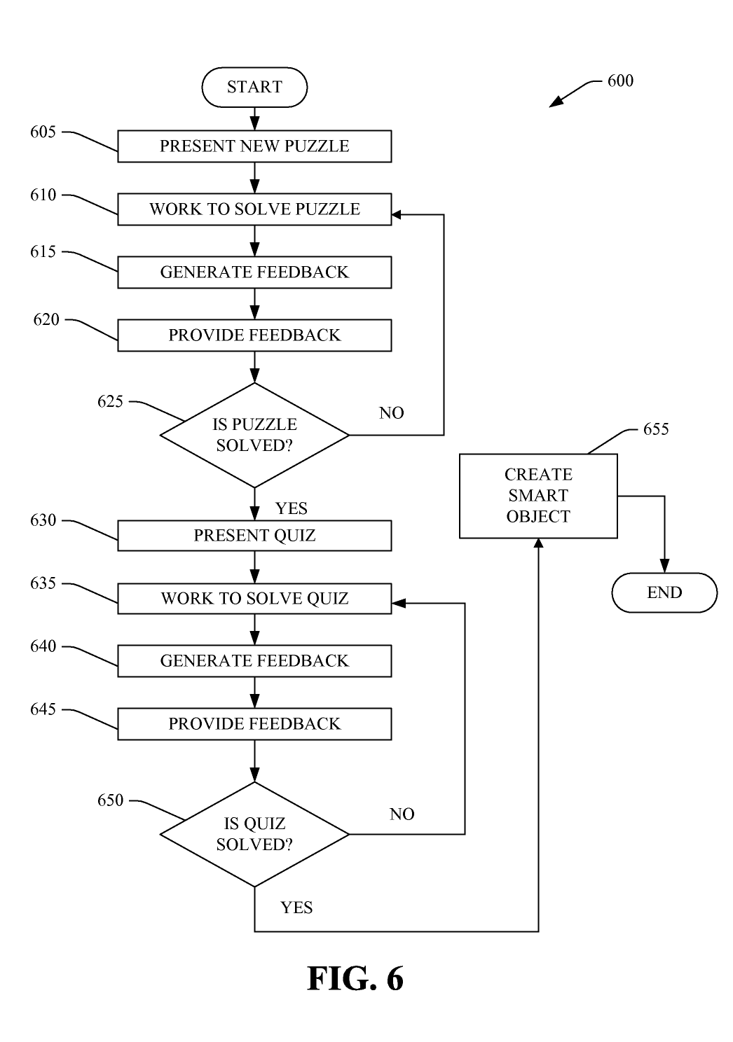

FIG. 6 is an illustration of a methodology for creating a smart object in accordance with an aspect of the claimed subject matter. At 605, a puzzle corresponding to and representative of an algorithm, or a base part thereof, can be presented for a user to solve. At 610, work is performed to solve the puzzle. At 615, feedback information regarding the user's action with regard to solving the puzzle can be generated. At 620, feedback information regarding solving the puzzle, or attempts to solve the puzzle, can be sent to the user. For example, the user can be presented with feedback information in the form of a textual message, graphical object, and/or audible sound informing the user that he has made an illegal move. In such a case, the puzzle can be returned to its state prior to the illegal move and the user can proceed from that point to continue solving the puzzle. At 625, a determination can be made as to whether the puzzle has been solved or otherwise completed. If the puzzle is not yet solved or otherwise completed, there is a return back to 610 to continue to solve the puzzle. If the puzzle has been solved or otherwise completed, the process can proceed to 630, where the user can be presented a quiz, for example an explanatory quiz, associated with the puzzle and underlying algorithm, for the user to solve. At 635, work is performed to solve the quiz, which can be in the form of questions calling for multiple-choice or textual responses, for example. At 640, feedback information associated with the user's actions with regard to the quiz can be generated. At 645, feedback information regarding solving, or attempting to solve, the quiz can be sent to the user. At 650, a determination can be made as to whether the quiz has been solved or otherwise completed. If the quiz has not yet been solved or otherwise completed, there is a return to 635 to continue to solve the quiz. If the quiz has been solved or otherwise completed, at 655, a smart object can be created, and the process ends. For example, the smart object can encapsulate the behavior of the algorithm, or part thereof, that has been or can be discovered by means of the puzzle just solved. A user can then use the smart object in a future puzzle, when such future puzzle can be solved, at least in part, by using the solution provided by the smart object.

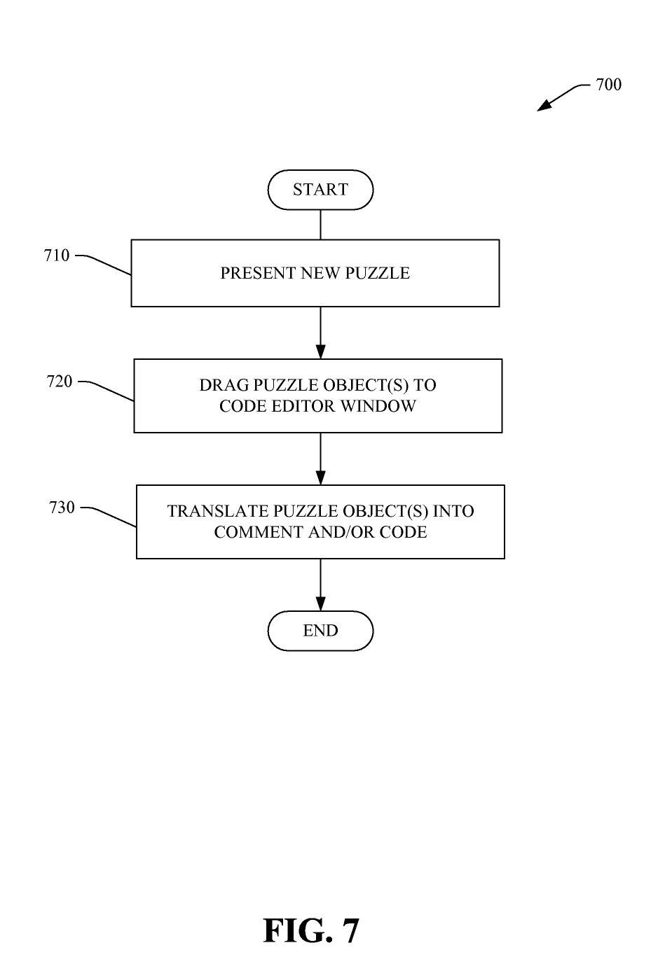

Turning to FIG. 7, a method for facilitating coding associated with a puzzle is illustrated. At 710, a new puzzle can be presented to the user via a puzzle display, for example. For instance, a puzzle comprising one or more graphical objects (e.g., puzzle objects) can be presented in the puzzle display. At 720, one or more puzzle objects can be dragged from the puzzle display to a code editor display. For instance, a mouse can be used to point and click on a puzzle object(s) and the puzzle object(s) can be dragged and dropped into the code editor display. At 730, upon be dragged into the code editor display, the puzzle object(s) can be automatically translated into comments and/or code, or fragments thereof, associated with the algorithm function represented by the puzzle object(s). The process then ends.

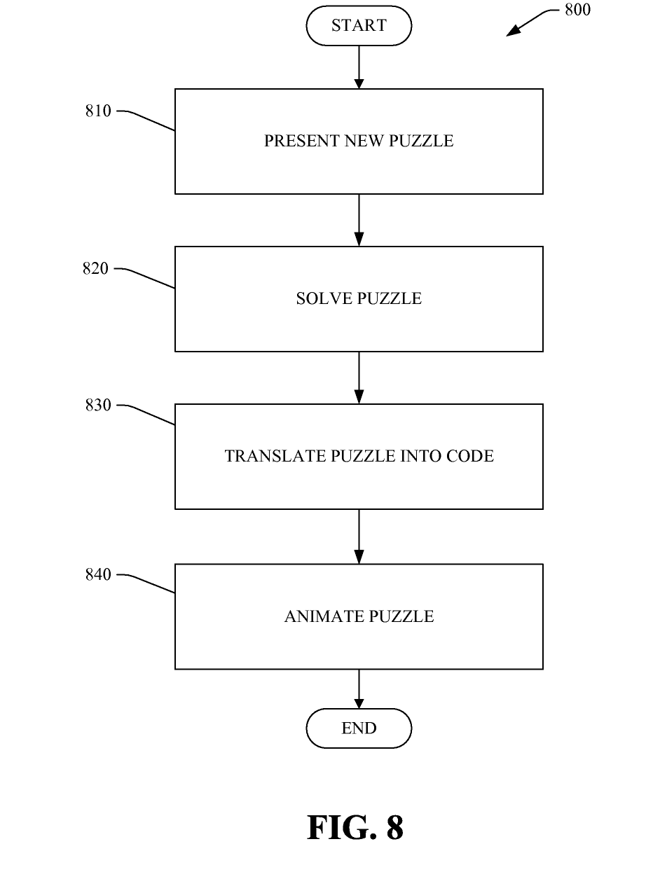

FIG. 8 is an illustration of a methodology of animating a puzzle in accordance with an aspect of the claimed subject matter. At 810, a new puzzle, comprising one or more puzzle objects, can be presented in a puzzle display. At 820, the puzzle is solved. At 830, the puzzle can be translated into code (e.g., C#) associated with the algorithm function represented by the puzzle. In accordance with one aspect of the claimed subject matter, the puzzle can be automatically translated into code upon being dragged into the code editor display. In another aspect of the claimed subject matter, a user can translate the puzzle into code by inserting code associated with the algorithm function represented by the puzzle into the code editor display. At 840, the code can be executed to animate the puzzle in a puzzle display. The process then ends.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

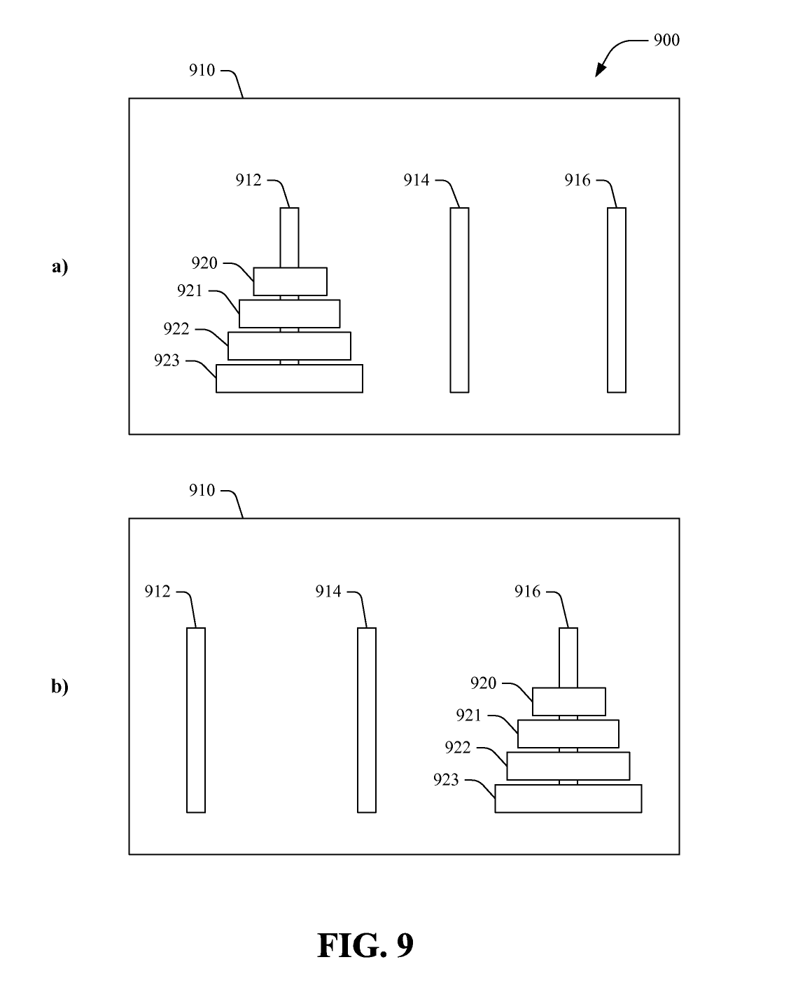

FIG. 9 is an illustration of an example of a puzzle that can be used in accordance with the claimed subject matter. The puzzle 900 known as the Tower of Hanoi is presented and can be displayed in a user interface 910. The puzzle 900 is representative of an algorithm, or a part thereof In solving the puzzle 900, a user discovers the behavior of the underlying algorithm, or part thereof, represented by the puzzle 900. At FIG. 9a, the Tower of Hanoi puzzle can be displayed in the user interface 910, in accordance with the claimed subject matter. The Tower of Hanoi puzzle can include a source pole 912, auxiliary pole 914, and destination pole 916. In the initial state 910, four disks 920-923 of different and increasing diameter, and having a hole in their respective centers, are placed on the source pole 912 with the largest disk 923 on the bottom of the source pole 912, the next largest disk 922 on top of disk 923, and the next largest disk 921 on top of disk 922, and the smallest disk 920 on top of disk 921. The goal of the puzzle is to move all four disks 920-923 to the destination pole 916, as shown at the puzzle's end state in FIG. 9b, by moving one disk at a time and without ever stacking a larger disk on top of a smaller disk. A further goal of this puzzle is to solve the puzzle using the smallest number of disk moves.

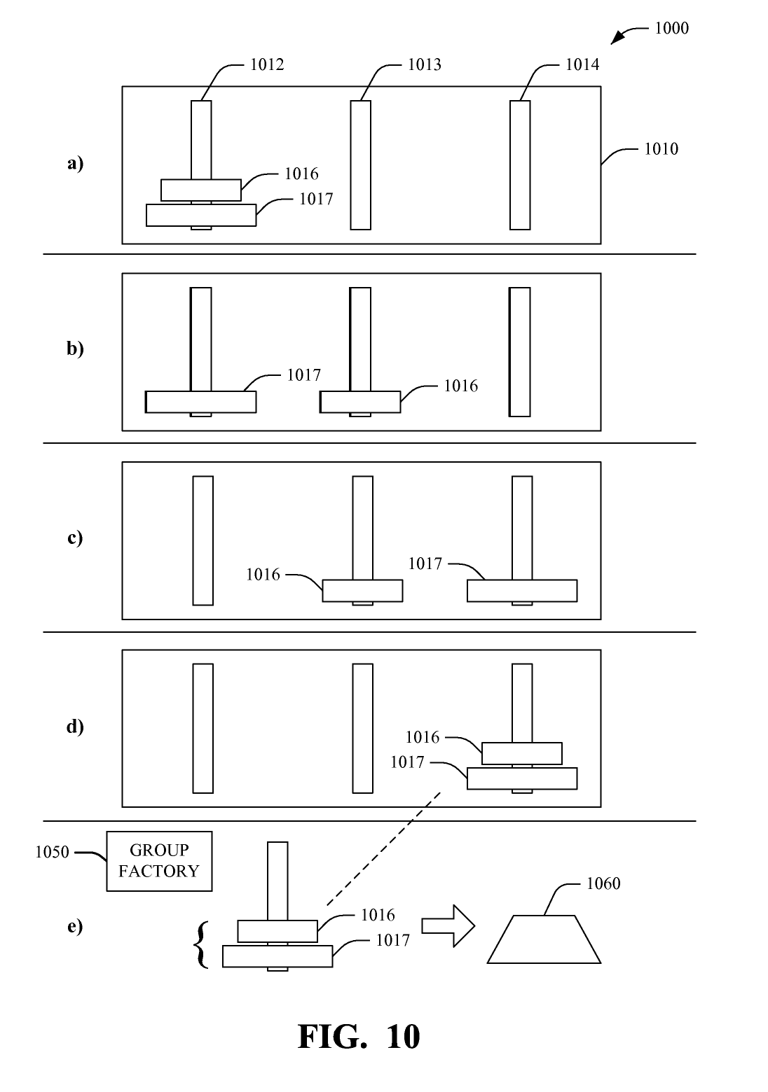

FIG. 10 is an illustration of an example of grouping puzzle objects based on a solution to a puzzle in accordance with the claimed subject matter. The puzzle 1000, which is a modified Tower of Hanoi puzzle, is presented and can be displayed in a user interface 1010. The puzzle 1000 is representative of an algorithm, or a part thereof. In solving the puzzle 1000, a user discovers the behavior of the underlying algorithm, or part thereof, represented by the puzzle 1000. In FIG. 10a, the modified Tower of Hanoi puzzle is illustrated with a source pole 1012, an auxiliary pole 1013, and a destination pole 1014, and two disks 1016-1017, differing in size and having holes in their respective centers, that are positioned with the larger disk 1017 positioned at the bottom of the source pole 1012 and the smaller disk 1016 positioned on top of disk 1017. In FIG. 10b, the smallest disk 1016 can be moved to the auxiliary pole 1013. In FIG. 10c, the larger disk 1017 can be moved from the source pole 1012 to the destination pole 1014. In FIG. 10d, the smaller disk 1016 can then be moved from the auxiliary pole 1016 to the destination pole 1014 thereby solving the puzzle for two disks 1016-1017.

In accordance with an aspect of the claimed subject matter, the solution for two disks 1016-1017 can be reused as in future puzzles, such as the Tower of Hanoi puzzle having three or more disks. For example, a group factory 1020, which is a function that can create of grouping of two or more disks, can form a grouped object 1030 that can represent the two-disk solution. The control for the group factory 1020 can be accessed via the user interface 1010. The grouped object 1030 can then be used in the three-disk Tower of Hanoi puzzle, for example. An example of a grouped object can be a smart object. Like a group object, a smart object can encapsulate the behavior of the algorithm, or part thereof, that has been or can be discovered by means of the puzzle 1000. The smart object can be used in a subsequent puzzle.

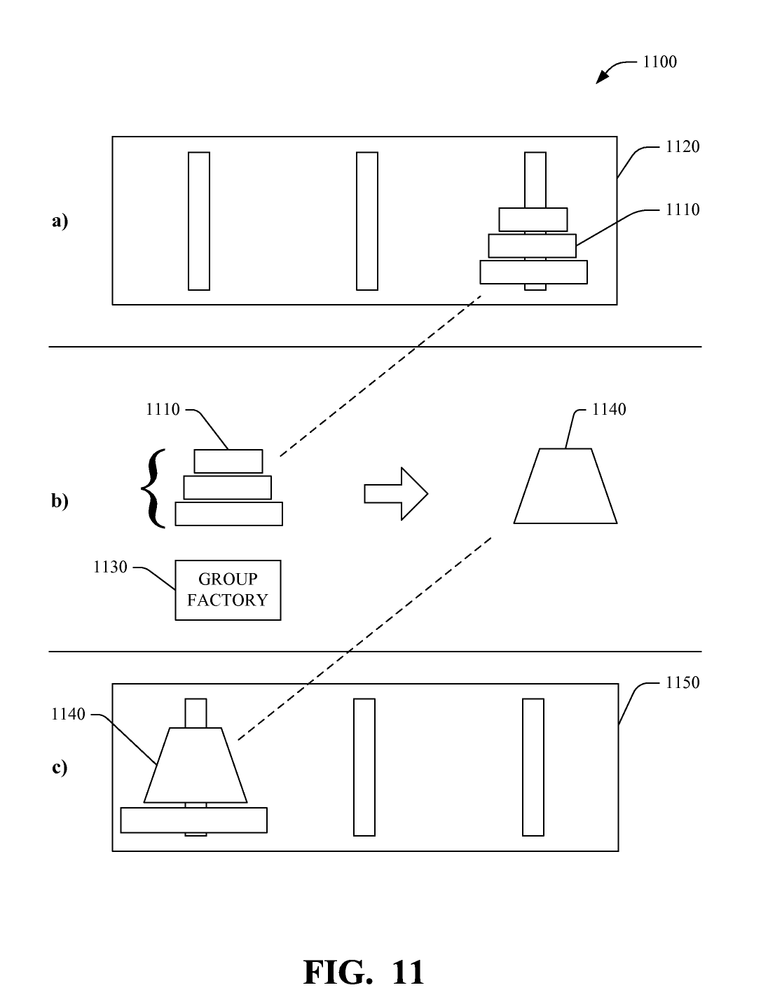

Referring to FIG. 11, an illustration of yet another example of grouping puzzle objects based on a solution to a puzzle in accordance with an aspect of the claimed subject matter is depicted. Puzzle 1100 is a modified Tower of Hanoi puzzle using three disks 1110 that can be displayed in a user interface 1120. The puzzle 1100 is representative of an algorithm, or a part thereof. In solving the puzzle 1100, a user discovers the behavior of the underlying algorithm, or part thereof, represented by the puzzle 1100. In FIG. 11a, the puzzle 1100 is shown at its end state, where it has been solved for three disks 1110. Once the user has solved a quiz associated with the puzzle 1100, the three-disk solution can be reused in subsequent puzzles by grouping the disks together, as shown in FIG. 11b, which can be accomplished by utilizing a group factory 1130. The group factory 1130 is a function that can create a grouping of two or more disks, and can group together the three disks 1110 of the solved puzzle 1100. The control for the group factory 1130 can be accessed via the user interface 1120. The three disks 1110, as grouped, can then be converted into a grouped object 1140. An example of a grouped object 1140 can be a smart object. Like the grouped object 1140, a smart object can encapsulate the behavior of the algorithm, or part thereof, that has been or can be discovered by means of the puzzle 1100. The grouped object 1140 can be used in a subsequent puzzle 1150, as shown in FIG. 11c.

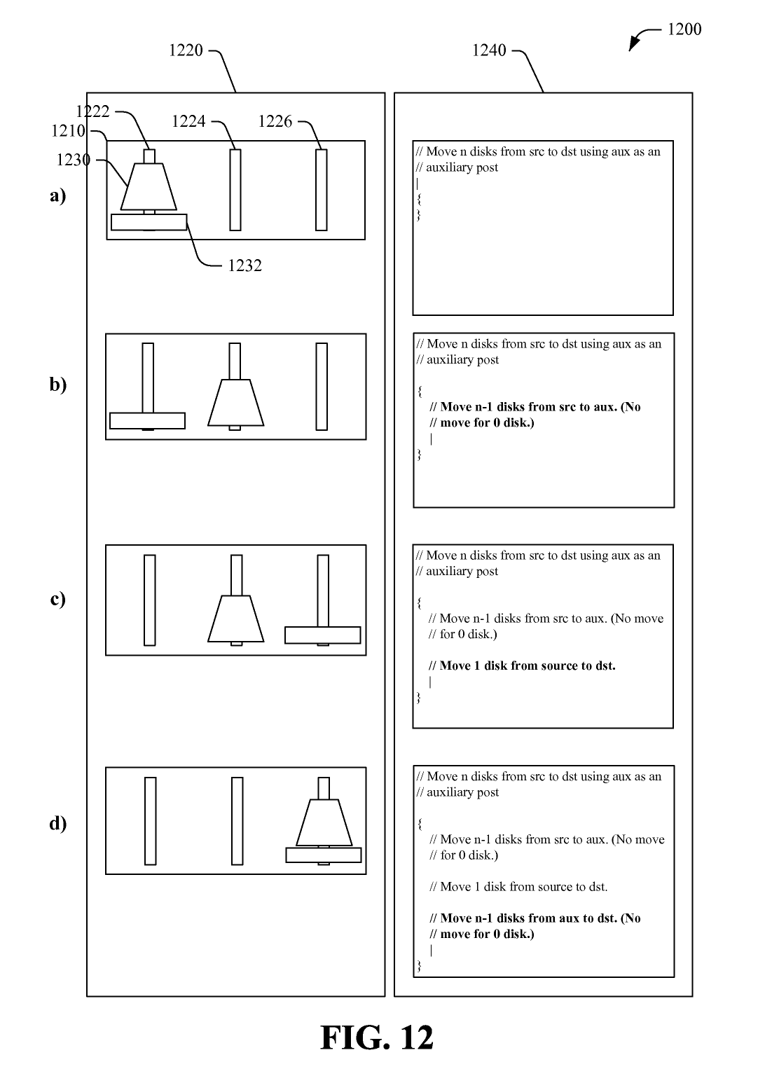

FIG. 12 is an illustration of an example of utilizing a grouped object to solve another puzzle in accordance with the claimed subject matter. The puzzle 1200, which is a Tower of Hanoi puzzle, is presented and can be displayed in a puzzle display 1210 in a user interface 1220. The puzzle 1200 is representative of an algorithm, or a part thereof. In solving the puzzle 1200, a user can discover the behavior of the underlying algorithm represented by the puzzle 1200. The puzzle 1200 can be constructed to include four disks. However, the user can utilize the two-disk solution utilizing a grouped object 1030 encapsulating the two-disk solution, as described in FIG. 10, or in the alternative, the three-disk solution utilizing the grouped object 1140 encapsulating the three-disk solution, as described in FIG. 11.

As shown in FIG. 12a, the puzzle is at its initial state and can include a source pole 1222, auxiliary pole 1223, and destination pole 1224. As shown, a grouped object 1230 is a disk grouping representing the three-disk solution of the Tower of Hanoi puzzle, such as the three-disk solution described in FIG. 11. The grouped object 1230 has a hole in its center so that it may be positioned on the poles 1222, 1224, or 1226. There is also a larger disk 1232 having a diameter that is greater than the diameter of the base of the grouped object 1230. The larger disk 1232 also has a hole in its center so that it may be positioned on the poles 1222, 1224, or 1226. By grouping the three disks together in the grouped object 1230, solving the puzzle 1200 for four disks has been made easier, as the puzzle has been reduced to a point that it may be solved in a manner similar to the two-disk solution. In solving the four-disk puzzle 1200, the user can utilize what has previously been learned in solving the three-disk puzzle and two-disk puzzle. The puzzle 1200 can thereby assist a user in understanding recursion.

An additional advantageous feature of the claimed subject matter that facilitates a user's understanding of recursion is the separation of induction (equivalently, recursion) levels during a complex action (e.g., during solution reuse). Thus, at the onset of each induction level, user input (e.g. a mouse click) can be requested. For example, when a three-disk group is being moved, the user can be prompted for input at the beginning, before each of the two two-disk moves, and then prompted for input again to continue after the second two-disk move.

As shown in FIG. 12b, the grouped object 1230 can be moved from the source pole 1222 to the auxiliary pole 1224. As shown in FIG. 12c, the larger disk 1232 can be moved from the source pole 1222 to the destination pole 1226. As shown in FIG. 12d, the grouped object 1230 can be moved from the auxiliary pole 1224 to the destination pole 1226, thereby solving the puzzle 1200 for four disks.

In an aspect of the claimed subject matter, when the user is attempting to solve the puzzle 1200 using a grouped object, such as grouped object 1230, the user has the option of having the grouped object 1230 move as a single action, or moving the grouped object 1230 can start an animation that will make all the moves that resulted in the solution associated with the grouped object 1230.

In accordance with another aspect of the claimed subject matter, upon completion of the puzzle 1200, a quiz can be presented for the user to solve in the user interface. The quiz can facilitate the user learning the algorithm represented by the puzzle 1200, including assisting the user in understanding how and why recursion works.

In accordance with yet another aspect of the claimed subject matter, a coding quiz can be presented to be solved by the user. One type of coding quiz can include code binding. In code binding, the puzzle 1200 can comprise a puzzle display 1210 in the user interface 1220 that can be associated with a code editor display 1240 displayed in the user interface 1220. By associating the puzzle display 1210 with the code editor display 1240, information, such as comments, the opening and closing of statement blocks, and/or code associated with the puzzle 1200, for example, can automatically be generated in the code editor display 1240 when an object 1230 or disk 1232 is moved or otherwise manipulated in the puzzle display 1210.

For example, as shown in FIG. 12a, puzzle display 1210 can show the puzzle 1200 at its initial state. The code editor display 1240 can display a comment that informs the user that he is to move n disks from the source pole 1222 to the destination pole 1226 using auxiliary pole 1224 as an auxiliary post. When the grouped object 1230 is moved from the source pole 1222 to the auxiliary pole 1224, as shown in FIG. 12b, the code editor display 1240 can display a comment that reflects the move (e.g., “Move n-1 disks from source to auxiliary. (No move for 0 disk.)).

In FIG. 12c, the larger disk 1232 is moved from the source pole 1222 to the destination pole 1226. The code editor display 1240 can automatically display a comment associated with the move performed in the puzzle display 1210. In FIG. 12d, the grouped object 1230 is moved from the auxiliary pole 1224 to the destination pole 1226. The code editor display 1240 can automatically display a comment associated with the move performed in the puzzle display 1210.

Once code binding has instantiated a template, in the code editor display, with comments and overall block structure, the problem becomes a traditional coding and debugging problem. The template that is built through code binding can typically be inserted in a file or code project containing initialization code and pointers to library functions to be used.

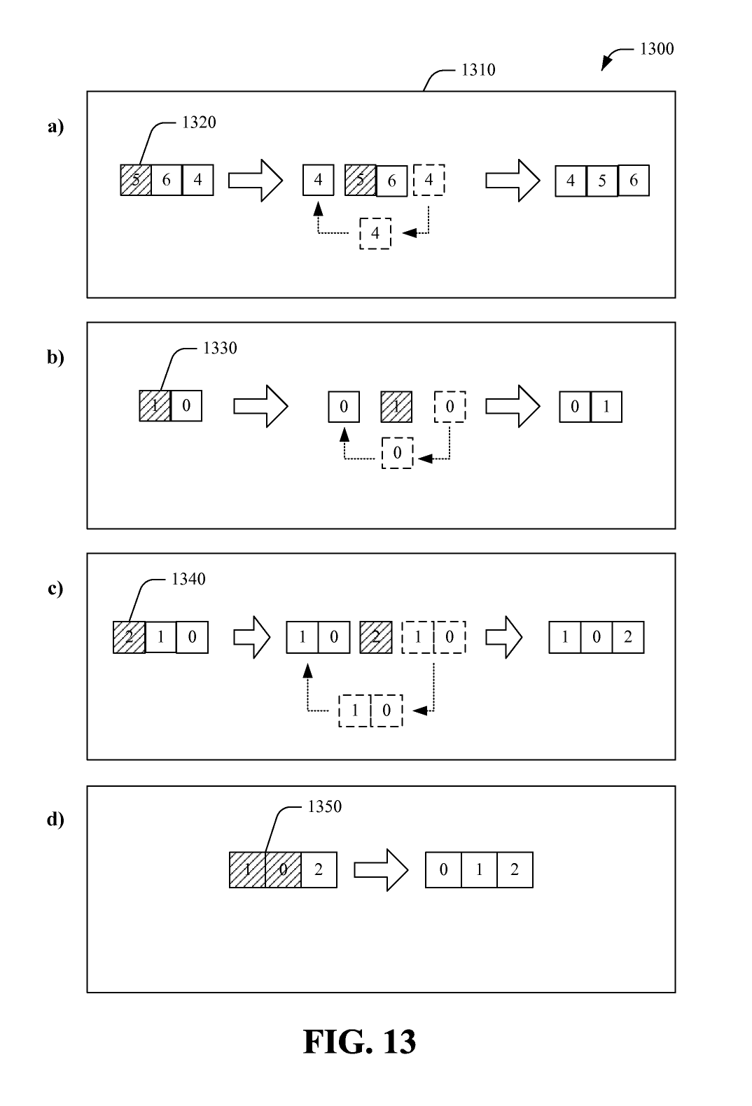

Turning now to FIG. 13, an example of a puzzle representative of a sorting algorithm that can be used in accordance with the claimed subject matter is illustrated. Puzzle 1300 is a puzzle that is representative of a sorting algorithm known as Quicksort. For example, given an array of numbers, Quicksort relies on repeatedly placing a “pivot element” at the final position it will occupy in the sorted array. Pivot placement in an array of numbers can comprise placing the pivot at a position where all numbers smaller than the pivot are at its left and all greater numbers to its right. In one version of the algorithm, the pivot element is the first element in the array to be sorted, although that is not always the case, and the pivot element can be any suitable element in the array.

In one aspect of the claimed subject matter, the user can attempt to solve the puzzle 1300 in a “freewheeling” manner without necessarily having to solve the puzzle 1300 in the most efficient manner, so that the user can become familiar with the puzzle. In another aspect of the claimed subject matter, there can be an autoplay function that can automatically solve the puzzle where the user can watch the puzzle being solved in a user interface 1310, for example. In yet another aspect, performance constraints can be placed on the user as the user attempts to solve the puzzle.

Turning to FIG. 13a, a puzzle can be presented in the user interface 1310 in accordance with the claimed subject matter. The puzzle can comprise an array of three elements in the following order: 5:6:4. To begin solving the puzzle, the pivot element 1320 selected is the first element in the array: 5. Next, the other items in the array can be reviewed to determine the next move. Since 4 is less than 5, 4 is moved to the left of 5 resulting in the elements being arranged as follows: 4:5:6. Since the elements are sorted, the puzzle is solved.

In FIG. 13b, the puzzle comprises an array of two elements as follows: 1:0. Being the first element, 1 is selected as the pivot element 1330. In reviewing the array, since 0 is less than 1, 0 is moved to the left of 1 in the array resulting in the array being arranged as follows: 0:1. Thus, this sorting puzzle is solved. This solution, like other solutions, can be available to the user as a canned solution (e.g., smart object) in subsequent puzzles. Using this puzzle as a base case, a subsequent puzzle can facilitate teaching an induction step by providing the canned solution whose behavior encapsulates the base case just discovered.

In FIG. 13c, the puzzle comprises an array of three elements arranged as follows: 2:1:0. Being the first element, 2 is selected to be the pivot element 1340. Further, 1:0 is a puzzle previously solved, which can be reused as a canned solution to solve the current puzzle. Since 1 and 0 are both less than 2, 1 and 0 are moved to the left of 2, so that the array is arranged as 1:0:2. As shown in FIG. 13d, the user can then select 1:0, as indicated at 1350, and use the canned solution for 1:0 to solve the current puzzle, resulting in the array being arranged as 0:1:2.

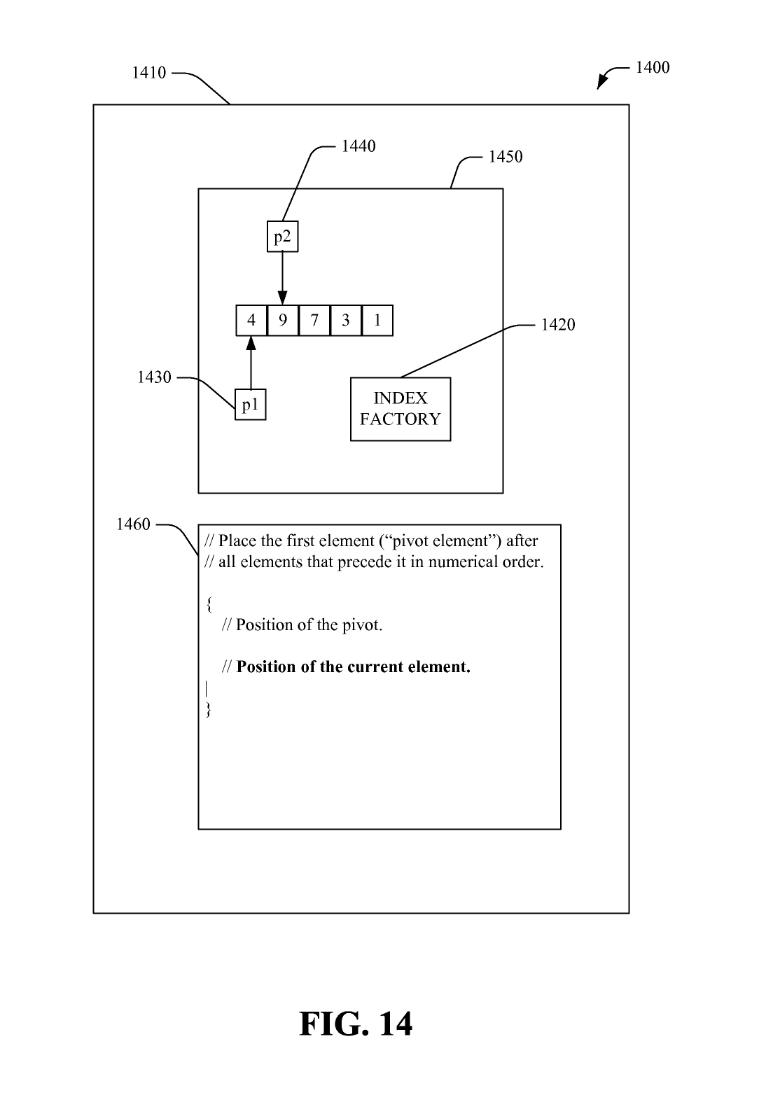

FIG. 14 is an illustration of another example of using a canned solution assist in solving a puzzle in accordance with the claimed subject matter. A puzzle 1400 in the form of an array representative of a Quicksort algorithm can be presented in a user interface 1410. The puzzle can include an index factory 1420 which is a control that is associated with an index component, “p1 ”, as shown at 1430, and another index component, “p2”, as shown at 1440. The “p1” 1430 can be utilized to set an initial location for the new index by clicking on any array item with a mouse in the user interface 1410, for example. The user can utilize “p2” 1440 to select an item to be moved and inserted at “p1” 1430. The index component, “p2” 1440, can be incremented or decremented so that it can be moved to items in the array. When “p2” 1440 is on an item that should be inserted to the left of “p1” 1430, the user can stop “p2” 1440 at that item so that item is selected, and then click on index component, “p1” 1430, and the selected item associated with “p2” 1440 can be inserted at “p1” 1430. The user can continue to manipulate the index components 1430, 1440 until the items in the array are sorted to solve the puzzle.

In accordance with another aspect of the claimed subject matter, code binding can be utilized to assist the user in drafting code associated with the puzzle and underlying algorithm. In code binding, the puzzle display 1450 is bound to a code editor display 1460 in the user interface 1410. Puzzle moves made by the user, or made automatically, are translated into comments associated with the puzzle moves. Once the puzzle has been solved in the puzzle display 1450, a template will have been formed in the code editor display 1460, where the template can be a linear representation of the logic necessary to solve the puzzle. The comments in the template can assist the user in creating executable code implementing the algorithm.

In yet another aspect of the claimed subject matter, with regard to the Quicksort algorithm, for example, puzzles and/or questions associated with the efficiency cost of moving certain items in an array can be presented to the user, so that the user is aware of such cost and can attempt to find the most efficient solution to the puzzle.

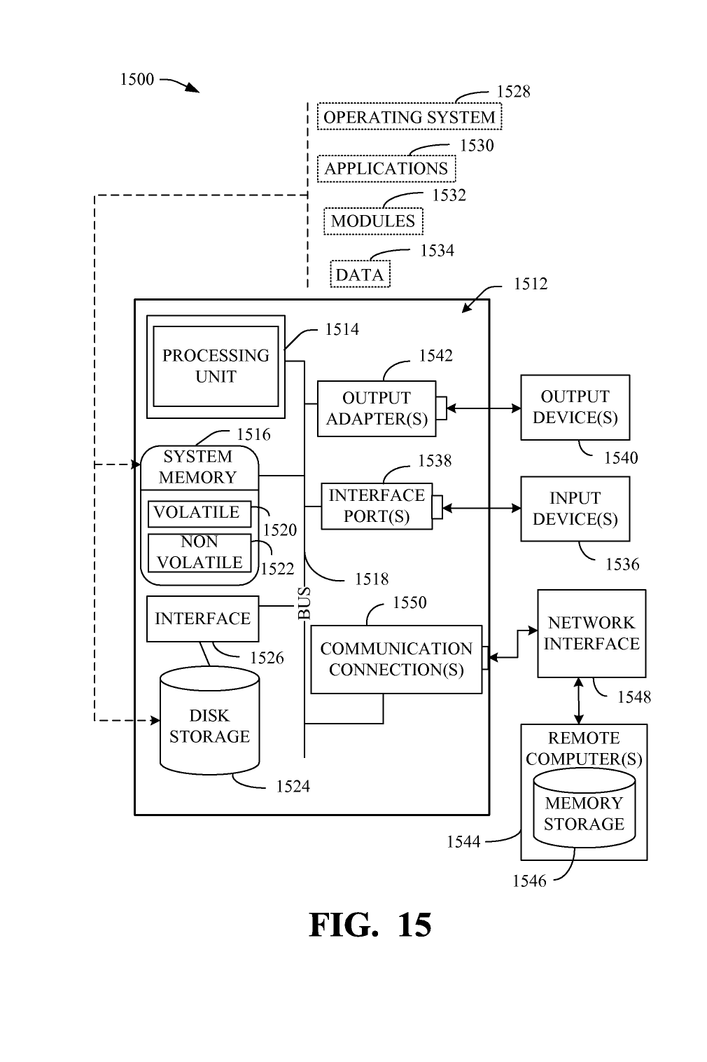

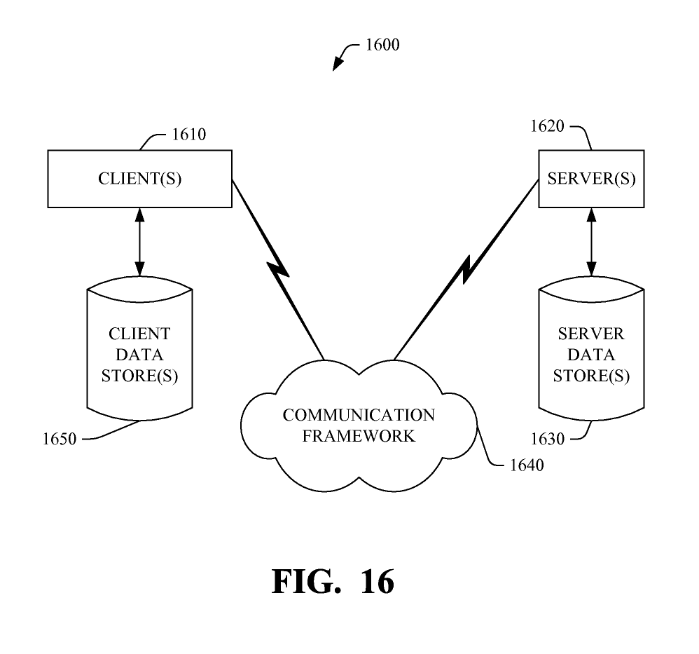

In order to provide a context for the various aspects of the disclosed subject matter, FIGS. 15 and 16 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 15, a suitable environment 1500 for implementing various aspects of the claimed subject matter includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable programmable ROM (EEPROM), or flash memory. Volatile memory 1520 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1512 also includes removable/non-removable, volatile/non-volatile computer storage media. FIG. 15 illustrates, for example, a disk storage 1524. Disk storage 1524 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used, such as interface 1526.

It is to be appreciated that FIG. 15 describes software that acts as an intermediary between users and the basic computer resources described in the suitable operating environment 1500. Such software includes an operating system 1528. Operating system 1528, which can be stored on disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the claimed subject matter can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512, and to output information from computer 1512 to an output device 1540. Output adapter 1542 is provided to illustrate that there are some output devices 1540 like monitors, speakers, and printers, among other output devices 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

FIG. 16 is a schematic block diagram of a sample-computing environment 1600 with which the subject innovation can interact. The system 1600 includes one or more client(s) 1610. The client(s) 1610 can be hardware and/or software (e.g., threads, processes, computing devices). The system 1600 also includes one or more server(s) 1630. Thus, system 1600 can correspond to a two-tier client server model or a multi-tier model (e.g., client, middle tier server, data server), amongst other models. The server(s) 1630 can also be hardware and/or software (e.g., threads, processes, computing devices). The servers 1630 can house threads to perform transformations by employing the subject innovation, for example. One possible communication between a client 1610 and a server 1630 may be in the form of a data packet transmitted between two or more computer processes.

The system 1600 includes a communication framework 1650 that can be employed to facilitate communications between the client(s) 1610 and the server(s) 1630. The client(s) 1610 are operatively connected to one or more client data store(s) 1660 that can be employed to store information local to the client(s) 1610. Similarly, the server(s) 1630 are operatively connected to one or more server data store(s) 1640 that can be employed to store information local to the servers 1630.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates learning an algorithm through rediscovery, comprising:
a user interface component that presents a puzzle representative of at least one algorithm component associated with a deconstructed algorithm; and
a learning component that provides feedback information of information to assist the user with solving the puzzle and learning the algorithm.

2. The system of claim 1, the puzzle comprises at least one graphical object.

3. The system of claim 1, the system further comprises a quiz component that presents a quiz associated with the algorithm.

4. The system of claim 3, the quiz comprises at least one of a multiple-choice quiz or a textual-answer quiz.

5. The system of claim 3, the system further comprises a smart object generator that generates a smart object that encapsulates behavior of the algorithm.

6. The system of claim 3, the system further comprises a progress component that monitors action of the user associated with the puzzle and the quiz, and generates progress information, based on user action(s), to feedback information back to the user.

7. The system of claim 1, the system further comprises a coding component that translates a graphical object into at least one of a comment or code associated with the algorithm when the graphical object is dragged into a code editor display.

8. The system of claim 1, the system further comprises an artificial intelligence component that makes an inference regarding what subset of feedback information to present to the user, the inference is based in part on current or past actions associated with the user.

9. The system of claim 1, the system further comprises a rule-based engine that compares an action of the user to a predetermined rule and makes a determination regarding the feedback information to be provided.

10. The system of claim 1, the system further comprises an animation component that animates the puzzle.

11. The system of claim 1, the system further comprises an algorithm modeling component that deconstructs the algorithm it into a plurality of components and generates at least one puzzle representative of at least one of the algorithm components.

12. The system of claim 1, the system further comprises a data store that receives and stores data associated with at least one of the algorithm, the puzzle, or the user.

13. The system of claim 1, the system further comprises a puzzle interface component that retrieves the puzzle.

14. A method that facilitates learning an algorithm, comprising:
presenting a user with a puzzle that corresponds to a base part of the algorithm;
generating performance and recommendation information as a function of user action associated with solving the puzzle; and
providing the user with a subset of the performance and recommendation information in connection with solving the puzzle to facilitate learning the algorithm.

15. The method of claim 14, further comprising providing the user with a quiz that corresponds to understanding the algorithm.

16. The method of claim 15, further comprising, upon satisfactory completion of the puzzle and the quiz, providing a disparate puzzle that corresponds to a disparate base part of the algorithm.

17. The method of claim 15, further comprising, upon satisfactory completion of the puzzle and the quiz, generating a smart object that encapsulates behavior of the algorithm associated with the puzzle.

18. The method of claim 14, further comprising making an inference, based in part on current or historical information associated with the user, regarding facilitating learning of the algorithm.

19. A system for learning an algorithm, comprising:
means for decomposing the algorithm into separate components;
means for associating a puzzle to the algorithm and the separate components;
means for monitoring progress in connection with solving the puzzle; and
means for providing feedback information associated with solving the puzzle.

20. The system of claim 19, further comprising:
means for providing a quiz associated with the puzzle;
means for monitoring progress in connection with solving the quiz; and
means for generating code associated with the puzzle.
